(19) United States
(12) Patent Application Publication
(10) Pub. No.: US 2001/0042058 A1
(43) Pub. Date: Nov. 15, 2001

(54) APPARATUS AND METHOD FOR MANAGING MEMORY USE BY SOFTWARE OBJECTS

(76) Inventors: ROBERT J. HARRINGTON, AUSTIN, TX (US); BRADLEY J. HLISTA, AUSTIN, TX (US)

Correspondence Address: MARC A HUBBARD, MUNSCH HARDT KOPF HARR & DINAN, 1445 ROSS AVE, SUITE 4000, DALLAS, TX, 75202

(21) Appl. No.: 09/112,735

(22) Filed: Jul. 9, 1998

(51) Int. Cl. G06F 7/00

(52) U.S. Cl. 707/1; 707/10

(57) ABSTRACT

A remote messaging system for distributed computer system includes a client stub (217) and client and server remote messaging engines (209, 211). The client stub and the client remote messaging engine prepare a server-ready object, referred to as a RemoteMethodObject (219) in response to client application logic (207) requesting a service from server (227) in the form of a call to the stub. The object is of a type corresponding to a particular service, and includes a header identifying its type and a user requesting the service. The object further includes data parameters for the service. The object's type, once received by the server, is identified, and a “handle” operation called. The method for the handle operation is bound to the object based on its type. SystemObject manager (221) manages objects that are instances of classes registered with it. The SystemObject manager pre-allocates memory, and subdivides the memory into elements called SystemObjects. Each RemoteMethodObject is mapped to a SystemObject when received. Other objects (223) can be created from SystemObjects. Each SystemObject includes basic information with which to manage usage of the memory element by an object.

### FIELD OF INVENTION

The invention pertains generally to computing systems and more particularly to systems for managing use of memory by software objects.

### BACKGROUND OF THE INVENTION

Networking is leading to increasing demand for distributed computing, particularly “client-server” style, in which one software entity—the “client”—requests a service from another software entity—the server. Due to the encapsulated nature of software “objects,” in particular their well-defined interfaces and decentralized data structures, object-oriented systems lend themselves naturally to distributed computing systems. Indeed, in an object-oriented computing system, it is possible for objects written in different languages, executing on different computing platforms, to provide services to each other through their publicly available interfaces.

Object Oriented Computing Systems. An object, from a programming point of view, is a software entity comprising a state and a set of defined behaviors. The state is represented by the values of “attributes” maintained by the object in a defined data structure. The behaviors are specified in terms of operations the object can perform. An object is, preferably, “encapsulated,” meaning that its internal structure is not available to other objects or software entities or processes. Rather, a message identifying one of its operations and any necessary parameters or arguments must be passed to the object. Thus, in effect, an object is made available only through an interface defined by the object's behavior and attributes.

In object-oriented programming methods, objects having like behaviors and attributes—in other words of the same type—are instances of a “class.” The class defines what attributes an object of the class can have and its behaviors, but not its state. For example, a class “person” may have attributes “name,” “sex” and “date of birth” and specify that values for each of those attributes be stored in a specific type of data structure. The class may have multiple instances, such as an object with a name attribute “Bob” and another object with the name attribute “Carol.” Each of these objects would be in a different state since the name attribute has a different value in the respective objects.

As actually implemented on a computer, an instance of a class, or object, is a runtime data structure, stored in memory and patterned after the class' abstract data structure. Operations of the class are implemented as executable code. The executable code for an operation is commonly referred to as a method. At run-time, the class also includes a mechanism for instantiating or creating multiple instances of itself as objects during execution. An object can invoke methods on itself, as well as on other objects, including invoking a method that creates a new object. Although, at a conceptual level, behavior and state of an object are bound together, methods are not actually stored as part of an object instance. Rather, only one set of methods is implemented for each class. When a call is made to invoke an operation on an object, the corresponding method is activated.

Several advantages come from a structured programming approach utilizing objects. First, encapsulation in a well-defined interface enables reusability and portability of code. Second, new, specialized classes can be easily derived from a general class. This process is termed inheritance, and it produces a subclass, in which the parent class' properties, i.e., its attributes and behavior, are combined with additional attributes and behaviors. When inheriting from a class, however, an inherited method may need to be redefined or modified. This may involve providing different coding for the method, as applied to objects of the subclass. The capability of a method to be applied to objects of different classes is called polymorphism and is another important feature of most object-oriented programming languages. At run time, a mechanism called dynamic binding allows the object system to choose the body of code appropriate for executing the method according to the class or type of the target object.

Distributed Object-Oriented Computing Systems. Interest in providing a universal standard to enable objects to communicate across different address spaces and different heterogeneous computing environments has led to the formation of several groups to formulate industry standards. One such group is the Object Management Group (“OMG”), a computer industry consortium. Their model for object-oriented computing systems in general, and distributed object systems in particular, is summarized below.

According to the OMG, an “object system” is a collection of objects that isolates a client from a provider of a service by a well-defined encapsulating interface. In object systems, a client is isolated from the actual implementation of the services as data representations and executable programming code. An object is thus, under the OMG definition, an identifiable, encapsulated entity that provides one or more services that can be requested by a client. A client need not be an object; it can be program or routine. A client requests services by issuing a request. A request is an event having associated with it information identifying a target object, an operation of that object which performs the requested service, and zero or more parameters. The parameters are used to pass data to the object that is the target of the operation. A computational object system of the server provides the mechanisms for realizing the behavior of requests. These mechanisms include definitions of object state, definitions of methods and definitions of how the object infrastructure is to select the methods to execute and to select the relevant portions of an object's state to be made accessible to the methods. A variety of implementations for an object are possible, including separate servers, libraries, a program per method, an encapsulated application, and an object-oriented data base, among others.

Communications in distributed applications. Splitting a client-server application across address spaces, physical machines, networks and/or operating systems forces an application programmer to deal with issues such as communication protocols, synchronization of requests and responses, and dissimilar representations of data on different computers. Many client/server application programs have communicated using a conversational, low-level, peer-to-peer network communication protocols, such as sockets. This required the application programmer to be mired in the details of communicating information across the network. However, various “middleware” is available for providing an applications programmer with off-the-shelf solutions. Remote procedure call (RPC) software is one example. RPC, which is sometimes a component or extension of a network operating system, hides the network by allowing an ordinary procedure call to be used in an application program to call a function handled by a routine on a remote server. The client process calls the function and passes parameters as in any other function call. The process (or a thread of the process) making the call then suspends, as with any other procedure call. Thus, the remote call is said to be “synchronous.” The RPC software then collects the values for the parameters, forms a message that includes the function call and parameters, and sends it to the server. The RPC software on the server, upon receiving the request, unpacks the parameters and calls the procedure. It also returns the results, if any, generated by the procedure.

To make a remote procedure call the client must know where the server is. The procedure may be “bound” to a particular server at the time the client code is compiled, through either hard coding or a configuration file. The client may also dynamically bind a server to the procedure call by looking up the server through a directory service on the network. This can be handled for the client by the RPC software. To handle packing and unpacking of parameters or arguments for a call, and any data conversion, a client and a server “stub” must be defined by the application programmer, compiled and linked to the respective client and server components of an application program. Stubs are compiled from an interface written by the applications programmer that describes the functions and parameters that a server is capable of providing a client. When an applications program makes a remote procedure call, the stub packages the parameters into a generic byte stream. This process is called “marshaling.” One of the purposes of marshaling is to handle parameters expressed as data types in a high-level language in a manner that is transparent to the application program. Thus, data types must be converted or flattened into a byte stream for transmission across a network. The client stub then calls the appropriate RPC runtime library routine to send the packet. The server stub parses the byte stream into parameters, copies each parameter to a local variable, copies the local variable to a stack, and then calls the function. The client and server stubs are symmetrical to allow the server to return to the client results.

Two major distributed-object models have been proposed to provide standardized approaches for distributed computing using component or object based software. These models are DCOM (Distributed Component Object Model) and CORBA (Common Object Request Broker Architecture). CORBA is an open infrastructure, defined by the OMG. DCOM is a standard proposed by Microsoft Corporation, and is the distributed extension of its Component Object Model (COM). Both CORBA and DCOM enable communication among object-oriented systems, as well as legacy systems not programmed using object-oriented models.

CORBA proposes using “object request brokers” (ORBs) to provide an RPC-like mechanism for transparently passing requests for services to an object. According to CORBA, an ORB establishes relationships between a client and a server object that resides in different address spaces, either on the same machine or on different machines across a network. Through an ORB, a client—which can be an object, process or other software entity that wants to make a request for services to a server object—invokes an operation on this object, without having to know where that object is located. The ORB intercepts the call and finds a server object that can implement the request. The ORB invokes the operation, and in doing so passes any parameters or arguments associated with the call. The client object need not be aware of where the object is hosted, the programming language used to implement the class of the object, or the operating system of the computer on which the object is hosted. Actual implementation of an ORB is left to its vendor. Thus, the ORB provides two primary roles. First, it provides common services, including basic messaging and communication between client and server, directory services, security services, and location transparency. Second, it insulates an application program from the specifics of a system's configuration, such as the hardware platforms and operating systems, network protocols and implementation languages.

An ORB is typically implemented as libraries that are linked with the client application and the server application. On the client side, a client stub provides a static interface to object services. From the perspective of a client object, the stub is a local proxy for a remote server object. The services offered by server objects are defined by an interface definition language (IDL), which is compiled to create run-time stubs. There must be one stub for each object class or component on the server that can be accessed by a client object. The client stub handles the function of marshaling the request, which is the process of placing the parameters or arguments that accompany the operation in a request into a communications buffer for transmission to the server. The server stub unmarshals or parses the arguments from a buffer on the server's machine and passes them in a call to the object. An object adapter sits on top of an ORB's core communication services. It receives requests for services from the client stubs on behalf of the server objects. It provides a run-time environment for instantiating server objects, passing methods to them, and assigning them an identifier (called an object reference).

The messaging component of an ORB differs from a traditional RPC in that a request in an ORB must target a particular object. A traditional remote procedure call would have a client process making a function call to a server process, without reference to any particular object.

### SUMMARY OF THE INVENTION

RPCs and ORBs tend to be slow and inefficient, and do not scale well, especially in unpredictable environments like the Internet. Asynchronous message queuing systems, in which a message requesting a service is placed in a queue for processing and the client requesting the service does not suspend while it waits for a return, can allow an application to scale to support greater numbers of service requests. However, the latency or delay between request and return in asynchronous messaging is not acceptable for many types of applications.

The invention has at its object an improvement in a computing system's ability to support greater levels of concurrency in an application, and thus also its scalability, particularly, though not necessarily, when distributed across different address spaces or different computing platforms. In a distributed computing environment utilizing the invention, a service provided by a server component is more scalable in terms of the number of concurrent clients that can be supported without significant degradation in performance, and is thus better able to handle unpredictable levels of demand for service.

The invention is hereinafter described in reference to a distributed computing system, in which a client requests a service from a remote server. This system supports greater levels of concurrency cfi.e. greater numbers of concurrent requests for service and concurrent users—through improved management of memory and communications processes at the server, and reduced processing overhead at the server associated with remote service requests. Several features of the system, each of which alone and in combination with one or more of the other features, achieves the objective of supporting greater concurrency and scalability in the application, especially when distributed across different address spaces or computing platforms.

One such feature of the disclosed system eliminates a need at the server to parse parameters or arguments, such as must be done in a remote procedure call or a CORBA-type of remote service request, prior to calling the procedure or invoking the method. A client process running on a client requests a service from a server process running on a server by making a call for the service to a client stub process. The client stub process creates an object, on which a predefined method of the server process may directly act. The object is of a type, i.e. class, corresponding to the particular service requested, or the particular operation of the services requested. This “server-ready” object is then transmitted to the server. When the server receives the object, a server process determines the object's type, stores the object and invokes a predetermined “handle” operation on the object. The “handle” operation has a different implementation for each service request, which is bound to the object once its type is determined. The client stub process marshals parameters for the call into a server usable data structure rather than a flat or generic byte stream for transmission to the server. Furthermore, a server stub process need not parse the byte stream into the constituent parameters by copying each parameter to a local variable, and then copying the local variables to a stack, prior to invoking the method. Thus, the amount of processing by a server of incoming requests for service is reduced as compared to a conventional ORB or a remote procedure call, and therefore greater numbers of users or requests for service can be accommodated without degradation of system speed and performance.

Another feature of the disclosed system is an apparatus and method for more efficiently managing memory usage, especially in unpredictable, high concurrency environments. One prior art approach is to allocate dynamically memory for an object after startup in response to an invocation to create the object, and then to de-allocate the memory when the object is destroyed. In a high concurrency environment, with constantly fluctuating numbers of objects, this technique tends to require significant processing overhead, to result in inefficient memory usage, and to risk the possibility of insufficient memory when needed. Another prior art approach is to create all the objects at startup, i.e. pre-allocate the objects. However, pre-allocating objects will tend waste significant memory resources in unpredictable and bursty high-concurrency applications.

Unlike the prior art, the apparatus and method for managing memory usage disclosed herein pre-allocates memory, preferably contiguous, and subdivides it into elements of, preferably, equal size. An element can be turned into, or store, an object of any one of a plurality of predetermined types. These memory elements are referred to herein as a “list” of memory elements. More than one list can be created, each possibly with a different element size. Information on use of each memory element is maintained in a data structure. In the preferred embodiment, each memory element contains a data structure to store at least some of this information, as does also each object that may be stored in it. However, this information could be stored elsewhere. Also, information for finding the location in memory of each element is maintained.

As compared with the prior art technique of dynamic allocation, this approach provides greater assurances of memory availability and tends to reduce processing due to dynamic allocation and de-allocation of memory. As compared to pre-allocation of objects, it will tend to result in more efficient memory usage, especially where two or more classes with objects of similar size are able to use the same list of memory elements for instantiating objects. Thus, unnecessary allocation of additional memory during runtime can be carefully controlled and, after destruction of an object, a memory element reclaimed for use by another object. Memory fragmentation can also be controlled. Although particularly useful in the distributed computing environment due to its support of bursty, high concurrency systems, this aspect of the disclosed distributed computing system may also be used to advantage in non-distributed computing environments. As part of an application development framework, it provides a mechanism that substantially reduces the burden on an application programmer to manage memory usage.

These and other aspects of the distributed computing system are described in detail below with reference to the attached drawing figures. The forgoing summary is not intended to define or limit the scope of the invention. Rather, the scope of the invention is limited only by the appended claims.

### BRIEF DESCRIPTION OF THE DRAWINGS

FIG. 1 is a schematic drawing of two computers communicating over a network.

FIG. 2 is a functional block representation of components of a distributed computing system, running an application with a client component and a server component.

FIG. 3 is a flow chart illustrating processes at a client for sending a request for service.

FIG. 4 is a class diagram for developing a client stub.

FIG. 5 is a class diagram for objects, called RemoteMethodObjects, which are constructed by the client stub and transmitted to request a remote service.

FIG. 6 is a schematic illustration of the basic structure of a data packet transmitting a RemoteMethodObject across a network.

FIG. 7 is a flow diagram of processes at a server associated with receiving a RemoteMethodObject.

FIG. 8 is a flow diagram of processes at the server for invoking a method, called “Handle”, on a RemoteMethodObject.

FIG. 9 is a flow diagram of processes at the server for sending a response to a request for service.

FIG. 10 is a class diagram for an object management system, referred to herein as the SystemObjects manager.

FIG. 11 is a class diagram of the SystemObjectBase and a representative subclass called DeveloperSystemObject.

FIG. 12 is a class diagram for objects called “Lists,” which maintain lists of SystemObjects.

FIG. 13 is a flow diagram of processes for allocating memory to SystemObjects.

FIG. 14 is a flow diagram of processes for creating SystemObjects in the allocated memory.

FIG. 15 is a flow diagram of processes for an application program to use SystemObjects as an object created by the application.

FIG. 16 is a flow diagram of processes for reclaiming SystemObjects no longer being used.

FIG. 17 is a flow diagram of processes for destroying SystemObjects.

### DETAILED DESCRIPTION OF PREFERRED EMBODIMENTS

In the following description, like reference numbers refer to like elements.

Referring to FIG. 1, representative hardware for a distributed computing system 100 includes two computers, 101 and 103 respectively, connected for communication through a network 105. Computer 101 is a general purpose computer. It includes a central processing unit (CPU) 107 for executing programming instructions, memory 109 for storing programming instructions and data during execution of software programs, and permanent storage 111 for non-volatile storage of data and programs. Similarly, computer 103 includes a CPU 113, memory 115 and permanent storage 117. All of the components and processes described herein are preferably implemented as software, i.e. stored programming instructions read from a storage medium and executed by the CPU 113.

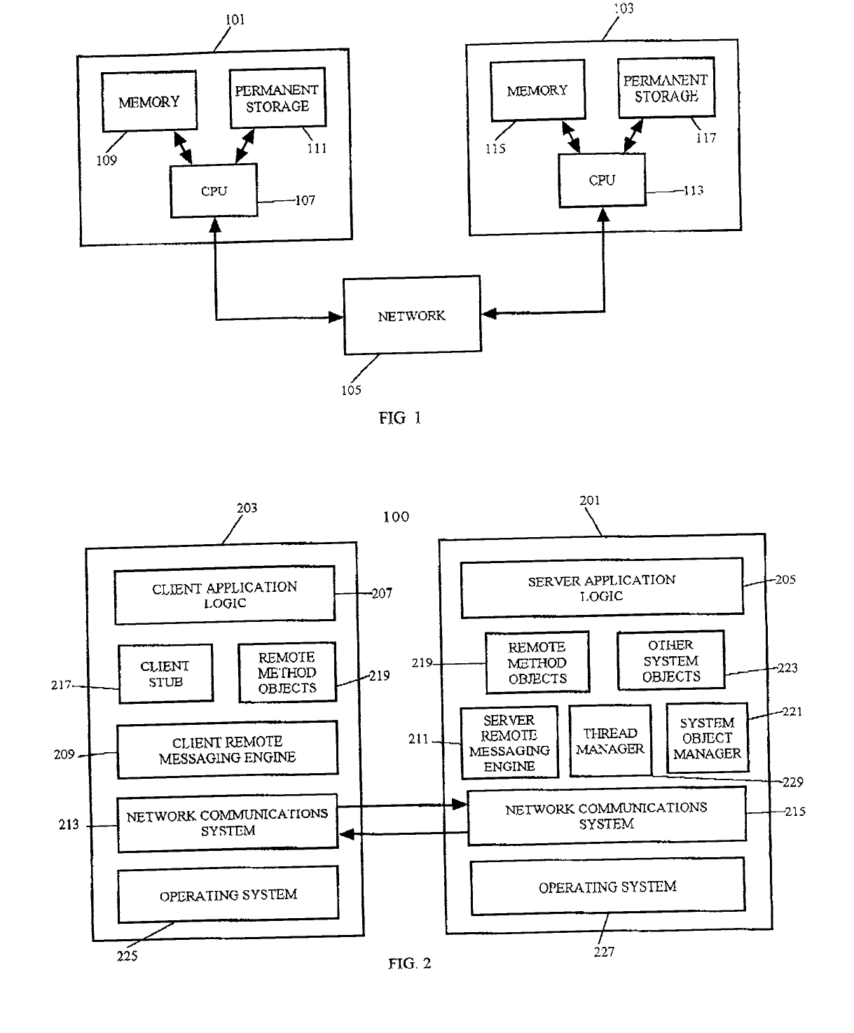

FIG. 2 is a schematic illustration of the basic, functional components of a distributed application and supporting messaging and memory management processes operating within distributed computing system 100. These components, and their operation, will be illustrated in reference to a “server” computer 201, which can take the form of computer 103 (FIG. 1) for example, and a “client” computer 203, which can take the form of computer 101 (FIG. 1) for example. The designations “server” and “client” refer to the fact that a computing entity (e.g. a process, an object, or a collection of processes or objects) running on computer 201, as represented by server application logic component 205, is proving services to a computing entity running on computer 203, as represented by client application logic component 207. However, any given computer may have applications that are servers and clients, or one application that is both requesting services from a remote server, and providing services to a remote client. “Server,” as used herein, will therefore refer to a computer process or entity that provides a service. “Client” will refer to a computer process or entity that requests a service. As a server and a client frequently reside on separate computers, the respective computers are sometimes also referred to as a “server” and a “client.” However, a server and client could also reside on the same computer or computing machine—for example, one that has multiple processors, or processes running in different address spaces. A “user” refers to the consumer of a service. A client could support more than one user. For example, a distributed game application may be processing several single-player games at the same time, in which case each game is a “user,” or a multiple-player game, in which case each player may be a user. A user need not be, or correspond to, a natural person. The concept of user allows one or more states to be maintained by, for example the server for each client. Finally, though the system is explained in reference to one client running on a remote computer, the system is intended to support many, concurrent clients and users requesting services of a server.

A remote messaging framework supports the client application logic 207 and server application logic 205. Software for this framework, for example, can be distributed to application developers on physical, computer-readable media such as CD-ROM or DVD or by transmission over a network. A developer will add application logic and distribute at least certain components of it with the applications logic. However, runtime versions of the framework may also be distributed separately or as part of, for example, a network operating system or a “middleware” type of component positioned between an application and an operating system, which provides additional services to the application.

The remote messaging framework includes, on the client side, a client remote-messaging engine component 209 and, on the server side, a server remote-messaging engine 211. The client and server messaging components each has an application programmer interface (API) for enabling a programmer of the client and server applications logic to interface with the messaging engines. These components will be explained in greater detail below. Both the client and server computer systems also have a network communications system, which are schematically represented by block 213 on the client and block 215 on the server. Furthermore, the client and server computer systems include operating system 225 and operating system 227, respectively. For reasons explained below, the server's operating system preferably supports multithreading in applications. However, no particular operating system is intended.

The network communications system provides the processing necessary to move data between the client application logic 207 and the server application logic 205 across a physical communications network interconnecting two computers. Most data communication networks today transport data in the form of a packet. Therefore, the distributed computing system will be described in reference to a packet model, although other types of communications systems can be used to exchange information within the distributed computing system. The implementations of the network communications systems referenced in blocks 213 and 215 are dependent, in part, on the communications media used to connect the respective computers to network 105 (FIG. 1), the types of networks to which the respective computers are connected, whether they are connected to the same networks, and other well known considerations. In the following description, the client 203 and server 201 will each utilize a “network protocol” stack implementing the Internet Protocol (IP) and the User Datagram Protocol (UDP), as well as the well-known standard “sockets” protocol. The IP protocol enables services to be rendered between networks. The connection-less UDP protocol requires less processing overhead than the more popular TCP transport protocol. Furthermore, the reliability achieved through the connection-type services offered by the TCP can achieved instead in a more efficient manner in a high concurrency environment by the remote messaging engines 213 and 215. The protocol stack may, alternately, be implemented, in whole or in part, in the client and server remote messaging engines 209 and 211, rather than as part of the network communication and/or operating systems represented by blocks 213 and 215.

Client stub 217 is a stub to which the client application logic directs a request for a service that is handled at server 201. The client stub acts as a static interface between the client application logic and the remote messaging engine 209. A request for service can be in the form of a function call declared in the client stub. “Service” as used herein refers to one or more operations that can be requested. An operation will sometimes be referred to herein as a “RemoteMethod” since it is being implemented in a method that is located at server 201.

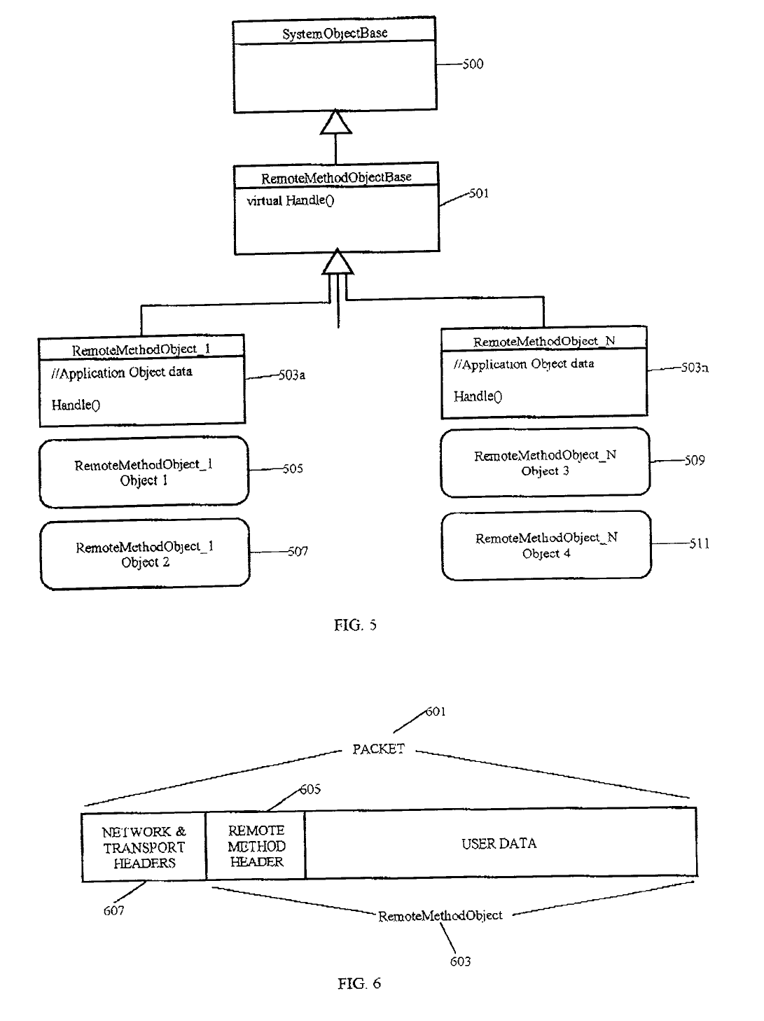

RemoteMethodObject classes 219 implement what is referred to herein as “RemoteMethodObjects.” A RemoteMethodObject is an object that is constructed on client 203 and transmitted to server 201. When constructed on the client, the object has a predetermined data structure that, once it is transmitted to server 201, can be directly acted upon by a predetermined method, which will be referred to herein as a “Handle” method. The RemoteMethodObject classes are preferably derived from a generic base class that is referred to as the RemoteMethodObjectBase class. The RemoteMethodObjectBase class is part of the messaging framework. There is one RemoteMethodObject class for each operation offered by a remote service that can be requested. The structures of the RemoteMethodObject classes are explained in connection with the description of FIG. 5.

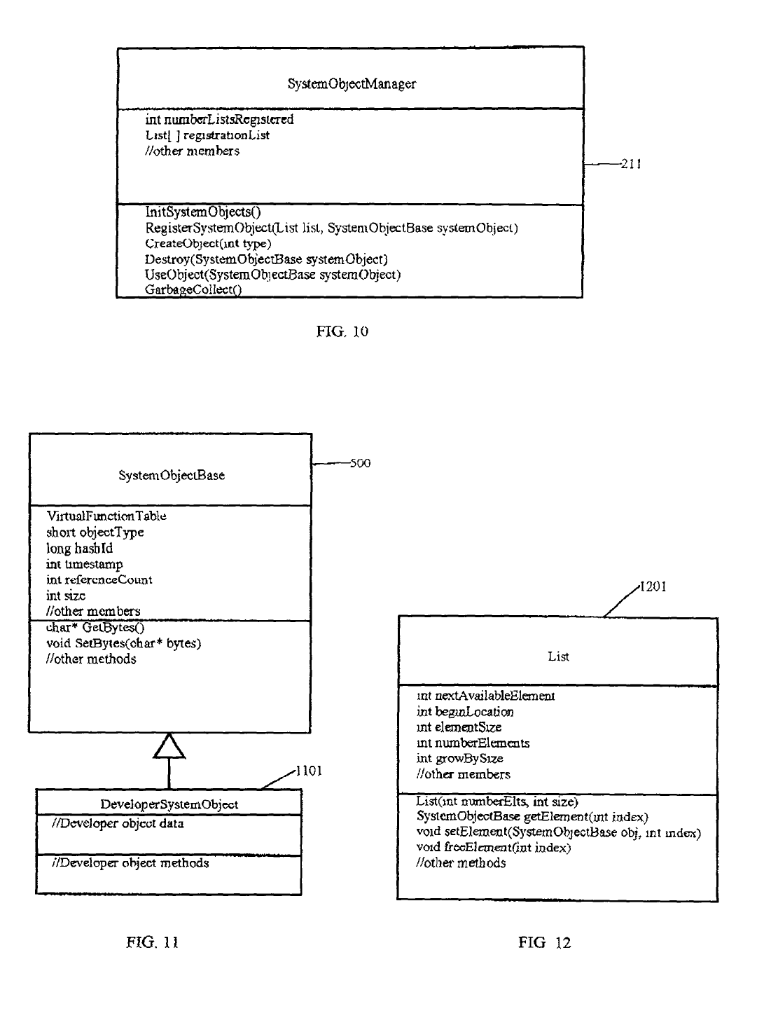

SystemObjects manager 221 is a runtime component that functions to allocate and manage memory in the server computer for use by objects that are instantiated using what is referred to herein as a “SystemObject.” The SystemObjects are generally designated by reference number 223. The SystemObjects manager also manages usage of the SystemObjects. Some objectives of the SystemObjects manager are to provide scalability of, and a relatively high level of concurrency (given the available computing system resources) in object-oriented software. The SystemObjects manager and the SystemObjects are explained in connection with FIGS. 10-17. Thread manager 229 is a component that manages allocation and use of threads by server application logic 205, as well as, optionally other application programs that may be running on server 201.

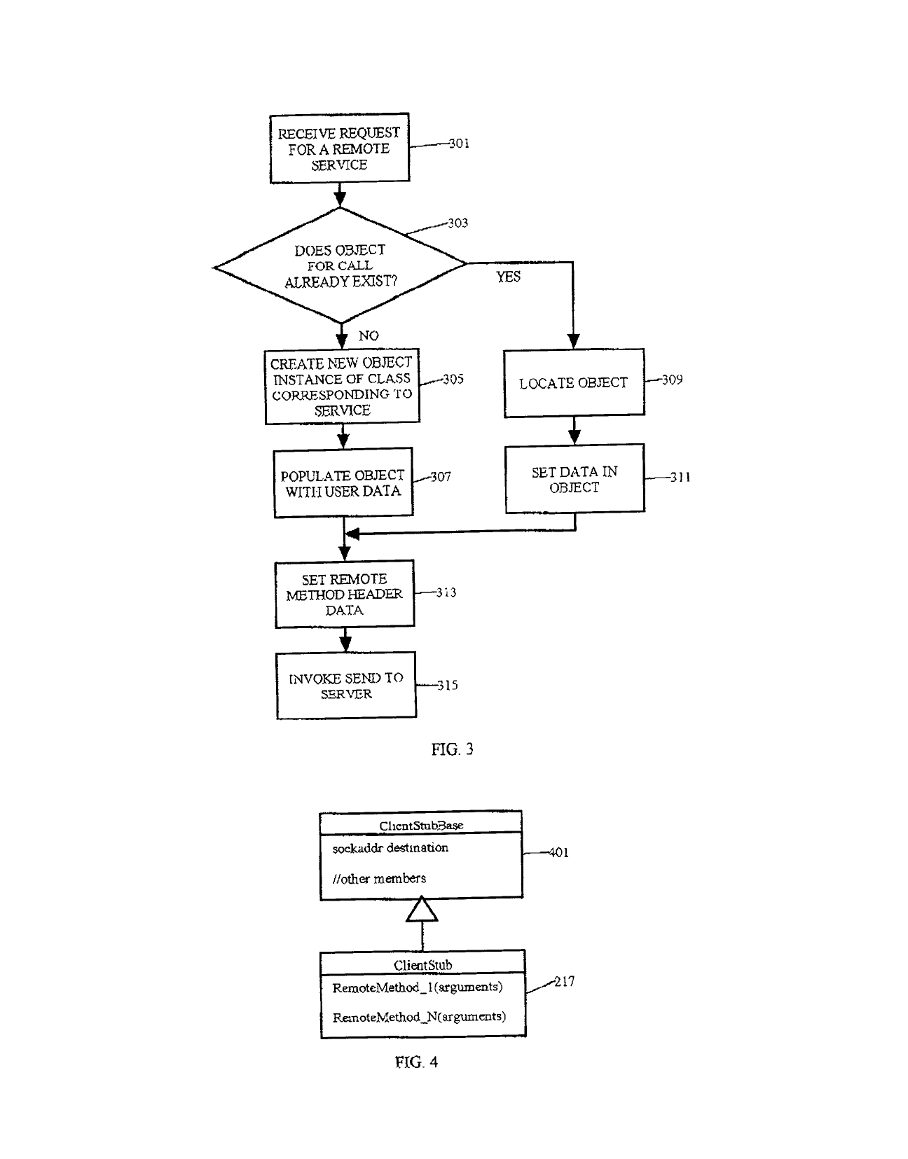

Referring now to FIG. 3, schematically illustrated are the steps of processing a request by client application logic 207 for a remote service. At step 301, the client stub 217 (FIG. 2) receives a call to a function, or an invocation for a method, that performs the service. This function or method, as previously mentioned, is referred to herein as a RemoteMethod. The client stub, remote method object classes 219 and client remote messaging engine 209 process the request as follows. First, as indicated by step 303, if a RemoteMethodObject for the requested service does not exist, the client stub invokes at step 305 construction of a new object of a type or class that corresponds to the requested service, i.e., a RemoteMethodObject of the type or class that corresponds to the RemoteMethod is constructed. At step 307, the new object is populated with data. The developer of the application logic specifies the structure and contents of the data, and thus the data that populates the object will sometimes be referred to herein as “user data.” The user data includes any arguments or parameters to the function or method that performs the requested service. Should the object for the request already exist at step 303, the object is located at step 309 and any new or different data is set in the object at step 311. At step 313, certain data in a header portion of object is set. As described in more detail below, the header portion of the object includes an identifier of the object and the object's type, an identifier of the user, and any other data that might be desired relating to security and reliability in the messaging process. A send process is invoked at step 315 to cause the object to be processed by the network communications system 213 (FIG. 2) for transmission to the server. To simplify processing at the client and the server, the UDP protocol, in which each object is treated as a single packet, is preferred.

Referring to FIG. 4, the client stub 217 (FIG. 2) is preferably derived from base class ClientStubBase 501. The client stub 217 is a subclass of the base class. This base class is part of the messaging framework, referenced above, that can be used by a developer to build a distributed application. The ClientStubBase class includes an attribute “sockaddr destination” which specifies the socket address of the server remote messaging engine 211. The socket address includes an IP address of the server computer and a port address specifying the application with which the sockets program will interface at the server. This address can be specified at the time the stub is compiled or in a configuration file accessed at runtime. Alternately, the remote messaging engine 209 can include a method for dynamically obtaining the socket address at run-time. An application developer will extend the ClientStubBase to create the Client stub 217 by defining at least one remote service or method. The illustration includes several RemoteMethods, namely “RemoteMethod_l” to “RemoteMethod_M.”

Referring now to FIG. 5, RemoteMethodObject classes implement the RemoteMethodObjects 219 (FIG. 2). As previously mentioned, a RemoteMethodObject is an object on which a method activated on server 201 may directly act once the RemoteMethodObject is transmitted to the server and bound to the method. The remote messaging framework includes a RemoteMethodObjectBase class. An application developer will extend this base class for each service offered by the server application logic. In the preferred embodiment, the RemoteMethodObjectBase class is derived from, or is a subclass of, another class referred to herein as a SystemObjectBase class 500. The SystemObjectBase class is described in connection with FIG. 11. Having a RemoteMethodObjectBase class inherit from a SystemObjectBase class provides a convenient mechanism to ensure that an instance of a RemoteMethodObject class can be managed by the SystemObject manager 221 (FIG. 2). However, it is not a requirement of the client and server messaging engine components 209 and 211 (FIG. 2) that the RcmoteMcthodObjectBase class be derived from the SystemObjectBase class.

The RemoteMethodObjectBase class declares a virtual “Handle( )” operation. The RemoteMethodObjectBase class is extended to provide one subclass for each service, as indicated by RemoteMethodObject_1 subclass 503a and RemoteMethodObject_N subclass 503n. Each RemoteMethodObject subclass declares a “Handle( )” operation and defines attributes of the user data that goes into each instance of the class. For purposes of illustration only, two instances of the RemoteMethodObject_1 subclass 503a are shown, namely the “object 1” 505 and “object 2” 507, as are also two instances of RemoteMethodObject_N subclass 503n, namely “object 3” 509 and “object 4” 511. These objects would be stored in memory in client 203 when they are created. The Handle( ) methods need only be activated on the server.

FIG. 6 is a schematic illustration of a packet 601 that results from the processes of FIG. 3, and further processing by the communication stacks in the network communications system 213. This packet represents the packet to be transmitted to server 201 (FIG. 2) over a network. The packet includes a RemoteMethodObject 603, as constructed on the client 203 (FIG. 2), including a header portion 605, referred to herein as the RemoteMethod header. It further includes a network communication header 607 inserted by the network communications system. The network communications headers include, for example, a UDP header and a media access header that enable routing through the network. As will be explained below, the RemoteMethod header 605 provides information that enables reliability and security processing by the server remote messaging engine 211 (FIG. 2), as well as mapping the object to a Handle( ) method for the object's class at the server 201 (FIG. 2).

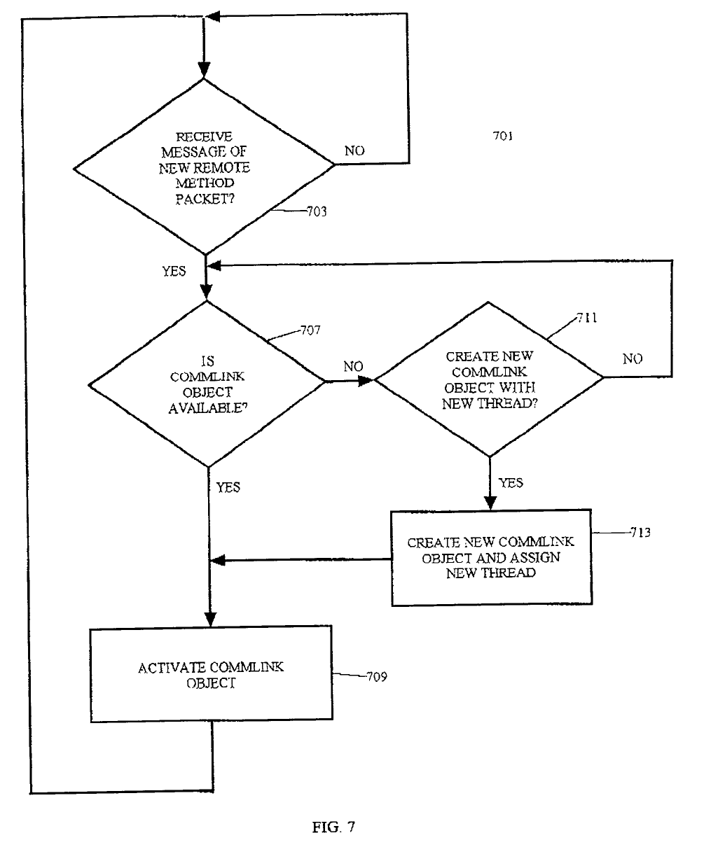

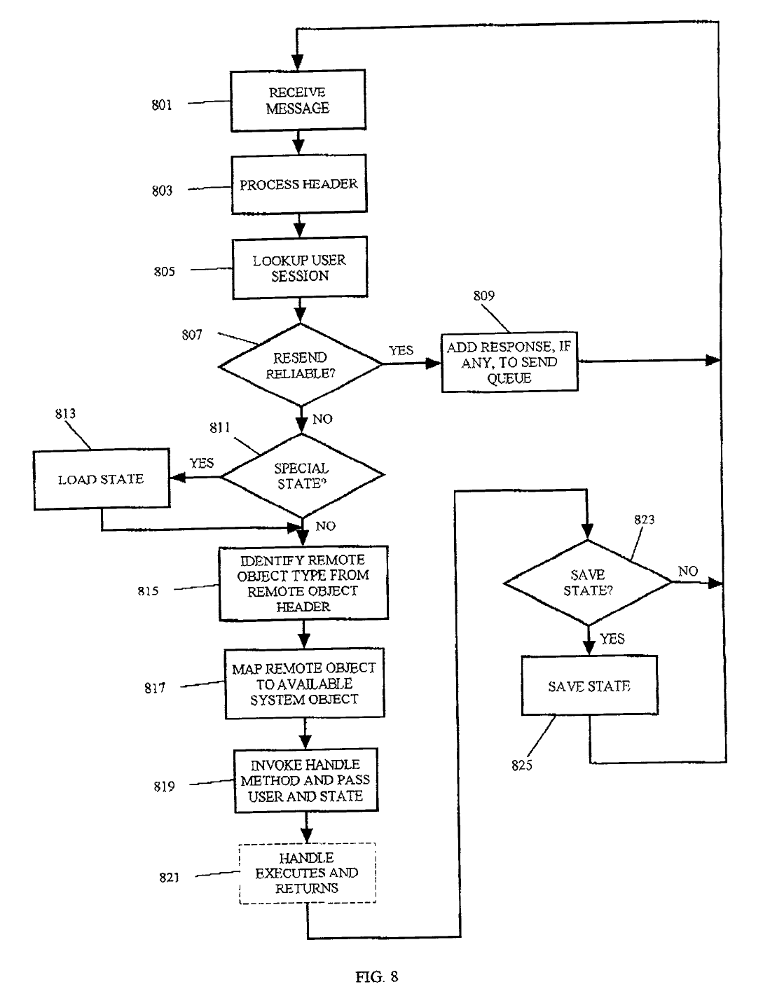

Referring to FIG. 7, once server 201 (FIG. 2) receives from a network a packet 601 (FIG. 6), it “de-multiplexes” the packet. De-multiplexing includes reading the various header layers of the packet and taking appropriate action. A protocol stack in the network communications component 215 (FIG. 2) reads the communications headers 607, performs the necessary processing and notifies the server remote messaging engine 211 (FIG. 2), which then begins its processing of the packet. A single “receive” process 701 is dedicated to continually run on its own thread of execution. Its basic task is to assign, from a pool of pre-allocated execution threads, an available thread of execution for use by a process, shown in FIG. 8, for de-multiplexing the RemoteMethod header 605 (FIG. 6). Thread manager 229 (FIG. 2) requests a predetermined number of threads from the operating system 227 (FIG. 2) when it is activated or when application server application logic 207 (FIG. 2) is activated. In the particular object-implemented embodiment described herein, the thread manager utilizes an object of a type referred to herein as a “CommLink” to represent each of the several pre-allocated threads comprising a pool of threads that will be available to the processes of the applications and other software components making use of the thread manager. The CommLink object contains information on the current state of the thread, and which method or object is using the thread. The thread manager invokes construction of a CommLink object for each thread and makes a system call to the operating system to assign a new thread to the CommLink object.

Beginning at step 703, the server remote messaging engine 211 receives a message from the communications system informing it of an arrival of a packet addressed to it. If, at step 707, a CommLink object is available, it is activated at step 709 and the method illustrated in FIG. 8 is invoked by passing a message that includes some handle or identifier for the RemoteMethodObject packet. If none of the CommLink objects are available, the process has the option, at step 711, to invoke creation of a new CommLink object and thus spawn a new thread. Whether it does so can depend on any number of criteria, including for example the nature of the service being requested, the user or system resource usage. If no new CommLink object is created, then the process loops back to step 707 and waits for one to become available. Otherwise, it creates a new CommLink object, obtains for it a new thread at step 713, and activates it at step 709.

Referring now to FIG. 8, a CommLink object to which further handling of an incoming RemoteMethodObject packet is assigned receives a message at step 801. A process invoked by the message determines, at step 803, whether the RemoteMethodObject header is valid. It does so by reading the object type from the RemoteMethodObject header. Security descriptors in the header may also be checked. If the RemoteMethodObject represents a message for a particular user session, the session state information for the user is looked up at step 805. User session state information is maintained for reliability and security in the transmission process. If the user state information indicates that RemoteMethodObject represents a repeat request for service, as indicated by step 807, a response to the first request is located in a response “pool,” where responses to service requests are kept for some period of time after being sent to ensure reliable delivery. This prior response is queued for sending at step 809. Next, at step 811, if the user session state information indicates that a special state, other than the user session state, is available for the user, it is loaded and mapped to a SystemObject at step 813. If the RemoteMethodObject represents a “stateless” request, step 811 is bypassed and the process proceeds directly to step 815.

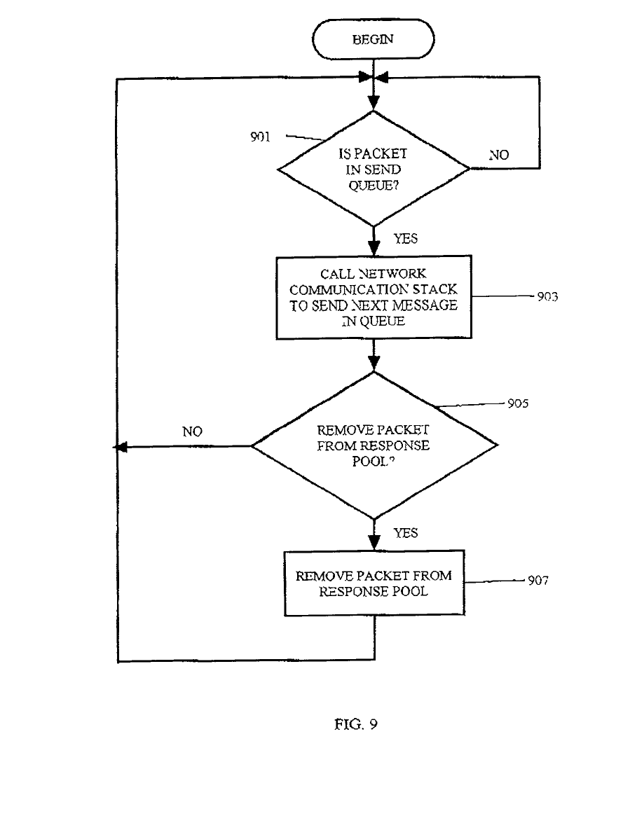

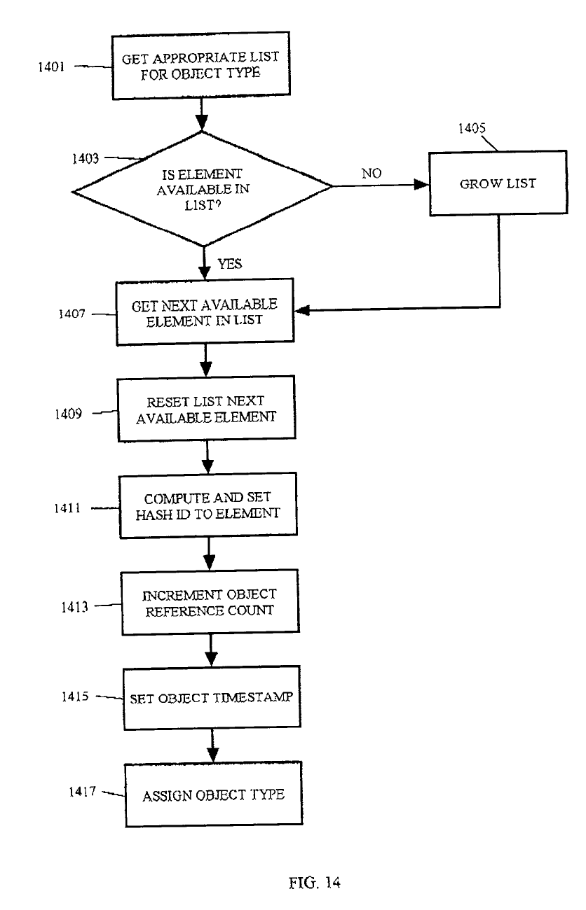

The object type is read from an identifier in the RemoteMethodObject header at step 815, and then it is mapped to an available SystemObject at step 817. Which SystemObject is chosen depends on the RemoteMethodObject type. During the mapping process, the RemoteMethodObject is copied directly into the memory location of an available SystemObject of a type corresponding to the type of the RemoteMethodObject. An attribute in the RemoteMethodObject header identifies its type. This attribute identifies the type of SystemObject to which the RemoteMethodObject will be mapped. The attribute will also be used to bind the implementations of the methods for that type to the particular RemoteMethodObject. For example, in some implementations, such as when using a C++ programming language, this attribute can be used to store a pointer to a virtual function table for that object type. This attribute can either be set during the mapping or, if the application developer knows it, the client stub can set it. The RemoteMethodObject can also be mapped by setting the SystemObject to the RemoteMethodObject type according to a process as substantially as described in FIG. 14, and then populating it with data from the packet. The Handle( ) method is then invoked at step 819 on this RemoteMethodObject, and parameters identifying any user and state object are passed. As previously described in connection with FIG. 5, the operation Handle( ) is defined in every RemoteMethodObject class. The actual processes of the Handle( ) method are, as previously explained, application-specific. A dashed box 821 therefore represents these processes, to indicate that they are not part of the remote messaging system engine process, but are executing along the same thread. It is up to the Handle( ) method, or other processes or methods activated by it, to carry out the requested service and to prepare return data by building a packet with a Remote Method header and the return data, and then mapping the return packet to an available SystemObject in a pool of SystemObjects set aside for responses. During this process, the user state and additional state may be modified. If, as indicated by step 823, the user state has changed, the application process saves the new state in step 825 before returning to step 801. If the user state data has not been altered, the process returns directly to step 801. As will be discussed in connection with FIG. 9, the SystemObject for the response will then be placed in a send queue. Control then returns to the receive process of the remote messaging engine when the process returns to step 801. At step 801, it checks the inbound message queue for another request and goes to sleep if none are available.

The flow diagram of FIG. 9 illustrates steps of a send process for transmitting response packets to clients. As previously explained, the send process always has control of at least one thread, and is thus always available. The process checks to see whether a response packet, which is an object—preferably a SystemObject—is in a send queue at step 901. Once a packet is in the send queue, the process calls at step 903 the network communications system. As indicated by steps 905 and 907, once it is sent, the process will either remove the packet from the response or keep it in a “response pool,” depending on the type of service. If reliability is required, the reference to the packet's object is maintained in the response pool for at least some predetermined interval or event, should it need to be resent, thus avoiding the need for further processing.

Turning now generally to FIGS. 10-17 for a description of SystemObjects, SystemObjects provide a mechanism for SystemObjects manager 211 to allocate memory in advance of its usage as an object, and thereafter to efficiently manage the use of memory by objects. A RemoteMethodObject, a CommLink object, a user state object or an application server logic object can each be implemented from a SystemObject. To facilitate management, each object to be implemented from a SystemObject preferably includes the same basic header structure. As used herein, the term SystemObject, used in a generic sense, refers to a pre-allocated memory element in a list. The pre-allocated memory element is not technically speaking an instance of a class, though it, in a preferred embodiment, possesses a header structure for storing the same attributes as found in the SystemObjectBase class 500. When a SystemObject is “used,” it becomes an instance of some class, for example, a user state class, a RemoteMethodObject class, or some other class of the server application logic 205 (FIG. 205). Therefore, objects belonging to classes managed by the SystemObjects manager will also sometimes be referred to herein as SystemObjects. In one preferred embodiment, each object is extended from a SystemObjectBase class. This ensures that the proper structure for managing the object is in place, while reducing the burden on developers utilizing SystemObjects. The SystemObjects manager can be part of a development library, or made part of an operating system. SystemObject manager 221 (FIG. 2), in its precompiled state, is represented in FIG. 10 by a class diagram, though it may actually be implemented in more than one class. Each SystemObject is an instance of a subclass 1101 derived from a SystemObjectBase class 500, as illustrated by the class diagram of FIG. 11. Each SystemObject is created within a predefined element of memory. Each memory element is preferably one of a sequence or series of contiguous memory elements that are allocated for creating SystemObjects of one or more types. In other words, it is a segment of addressable memory logically divided into a plurality of elements, each element being of equal size. These sequences or series of elements are referred to herein as “lists.” Detailed information helpful in managing the memory elements in a particular list of elements is kept in a “List” object. FIG. 12 is a class diagram of a “List” class used by the preferred embodiment illustrated herein. All objects maintaining a list of memory elements are, in the embodiment described herein, instances of this class.

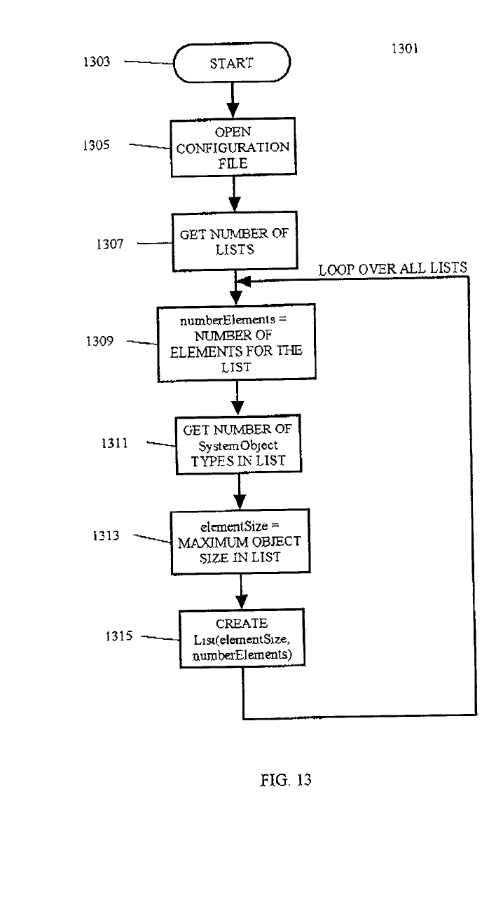

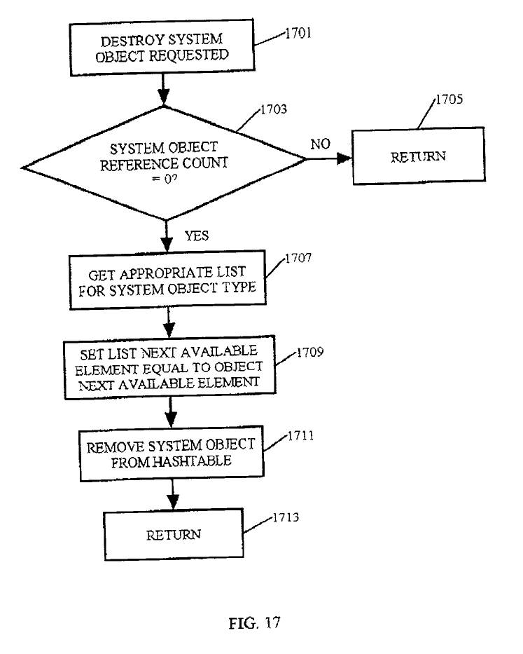

Referring now to FIG. 10, the SystemObject manager 211 (FIG. 221) has attributes with which to track the number List objects that it manages and the identity of each List object. “numberListsRegistered” is an attribute that stores a value for the number of lists that are registered with the particular instance of the SystemObject manager. “List[] registrationList” is a list of classes of objects that will be managed by the SystemObject Manager. Such classes are “registered” with the SystemObject manager. For example, these classes would include, in the preferred embodiment, the RemoteMethodObject classes. Should the SystemObject manager be used without the remote messaging engine, these classes could include any class of an application or other software component. The SystemObject Manager also has several methods. “InitSystemObject” is a method called to pre-allocate the memory elements for each class registered with the SystemObjects manager. The processes of this method are illustrated in FIG. 13. “RegisterSystemObject” calls a method that adds a class that will be managed by the SystemObject manager. “CreateObject” calls a method to create an instance of a particular type of object from an available SystemObject. Processes for this method are schematically illustrated in FIG. 14. “Destroy” is a method by which an object of a particular type is destroyed and the SystemObject from which it was created is destroyed. These process are schematically illustrated by FIG. 17. “GarbageCollect” invokes a method for carrying out the processes schematically illustrated in FIG. 16.

Referring to FIG. 11, the SystemObjectBase class 500 has several data attributes. These attributes are, thus, found in each object class registered with the SystemObjects manager. “virtualFunctionTable” is a pointer to the object's virtual function table. “objectType” stores a character string that can identify the object's type. This string could also be used as a pointer or reference to a virtual function table for its methods, depending on the specific implementation. “hashID” is a unique identifier for the object. “timestamp” stores a time stamp. “referenceCount” stores the number of references to the object. “nextAvailableElement” is a pointer or reference to the next available SystemObject. “size” is a value identifying the size of the SystemObject. The SystemObjectBase class serves a root class for all other objects that will be managed by the SystemObject manager 211 (FIGS. 2 and 10). “DeveloperSystemObject” is an example of a subclass, to which a developer has added certain attributes and methods specific to the developer's application. Similarly, classes used in the implementation of the client and server remote messaging framework described herein, namely the RemoteMethodObjectBase class, are preferably derived from the SystemObjectBase class 500. However, it is not necessary that they be derived from this base class if they otherwise possess the necessary attributes and behavior for being created from a SystemObject and managed by the SystemObject Manager.

Referring to FIG. 12, List class 1201 includes the following attributes. “nextAvailableElement” is a pointer or reference to a next available memory element that has been allocated for use as a SystemObject of the type managed by a particular instance of the List. “beginLocation” is a pointer or reference to the location of the beginning element in the list of memory elements managed by a particular instance of the List class. “elementSize” is the size in, for example, bytes of each memory element. “numberElements” is the number of member elements managed by a particular instance of List. “growBySize” is a value indicating the number of elements to add any time more memory is allocated. The methods of the List class include “List,” “getElement,” “setElement” and “freeElement.” The method List actually creates the list of memory elements. The method getElement obtains the value of the attribute nextAvailableElement. The method setElement carries out processes for turning a SystemObject into an object of a particular type by, for example, setting the object type and hash identification code to serve as a handle to the object. The method “freeElement” releases a particular SystemObject from use as a specific type of object so that it will be accessible with a “getElement” call.

Referring now to FIG. 13, SystemObject manager 211 undertakes memory allocation process 1301 upon activation at step 1303. First a configuration file is opened at step 1305. This configuration file provides basic information for initially allocating memory allocation and creating SystemObjects. For each List to be created, steps 1309, 1311, 1313 and 1315 are undertaken. At step 1309, the attribute “numberElements” is set equal to the number of elements specified for the List. At step 1311 the object types to be managed by the List are obtained. “elementSize” is set equal at step 1313 to the maximum size of the object of types managed by the list. And, at step 1315, the memory is allocated for the elements, and a basic data structure of the SystemObjectBase is imposed in order to have use of certain of its attributes to store data in each of the memory elements for facilitating management of the memory elements. These attributes, in the preferred embodiment, include some or all of those of the SystemObjectBase 500 (FIG. 11): the virtual function table pointer, object type, time stamp, reference count and size attributes.

FIG. 14 illustrates processes involved in creating an object of a specific type from a SystemObject. At step 1401, the SystemObject manager gets the List object with which the object's class is registered. Since a SystemObject is, at this stage, an element of memory set aside for creation of one or more specific types of objects, the following process will be described in reference to memory elements. If, as indicated by steps 1403 and 1405, a pre-allocated memory element is not available, the List is “grown” by allocating additional memory elements to the List. At step 1407, a pointer or reference to the next element in the list available for use as an object is obtained from the List object and is stored as the new value for nextAvailableElement. A new reference or pointer is calculated and stored for the nextAvailableElement at step 1409. The data structure of the object type is then imposed on the element and the data values set in a series of processes during the following steps. At step 1411, a hash code is computed and stored as hashID. The hashID is used as an identifier for the object, and is also maintained in a hash table for looking up a pointer or reference to the object. At step 1413 a count of the number of times the object is referenced is incremented by one. It is stored in the variable referenceCount. The object's time stamp is set at step 1415 and the objectType attribute is set at step 1417.

For example, a mapping of a RemoteMethodObject, as discussed in connection with FIG. 8, is essentially creation of a new instance of a RemoteMethod class. Copying the RemoteMethodObject from the communications packet into the memory element sets the data elements in a very simple manner, with relatively low processing overhead. The RemoteMethodObject instance will, since it was preferably derived from the SystemObject class, already possess attributes for storing the hash ID, referenceCount and objectType. Similarly, the user state classes are preferably derived from the SystemObjectBase class. Thus, to create a new user state object, a new SystemObject of the respective type is created.

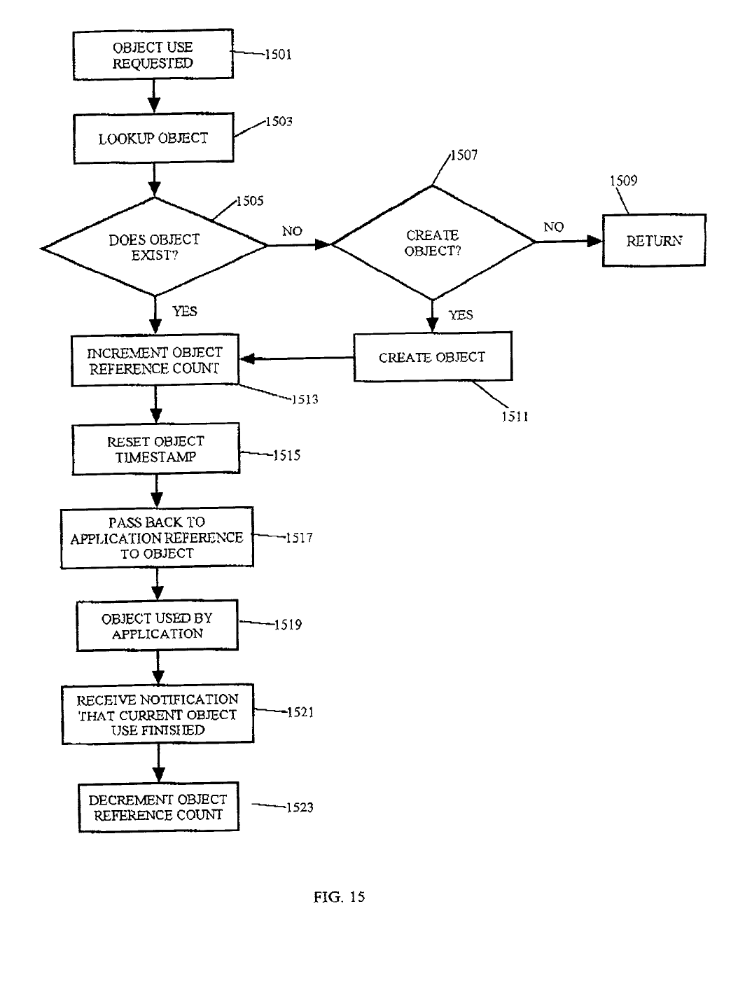

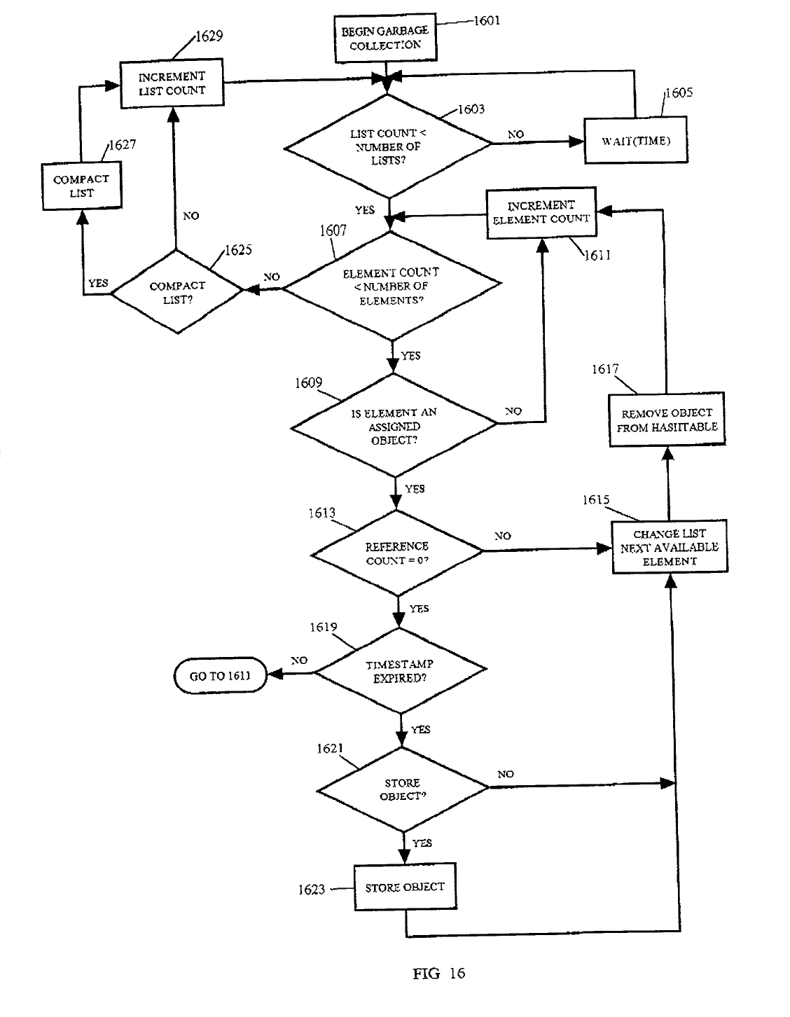

Referring now to FIG. 15, each time an object managed by, or registered with, the SystemObject manager is used, such as by reference or invocation of a method on the SystemObject, a request to use the object is made at step 1501 by passing a reference in the form of the hash ID. The hash ID is looked up in a hash table. If it is determined at step 1505 that an object with that hash ID does not exist, the process will determine whether it should create a new object at step 1507. A programmer of the class seeking use of an object could choose not to create additional objects based on any number of criteria. If an object does not exist for the hash ID, an exception is returned and the process returns at step 1509 to the beginning. If a new object is permitted to be created, it is created at step 1511 using the process described in reference to FIG. 14. Once the object is created at step 1511, or it is determined that one exists for use at step 1505, its reference count is incremented at step 1513 and its time stamp is reset at step 1515. These parameters are used for garbage collection purposes, as explained in connection with FIG. 16. A reference back to the object is, at step 1517, passed back to the method or process making the request. The object is thereafter used at step 1519 by the method or program requesting use. Once the method or program finishes using or referencing the object, it is required to pass a message at step 1521 that decreases the reference count for that object at step 1523. Multiple methods or programs could seek to use the object by obtaining a reference to it.

Referring to FIG. 16, to free memory, a garbage collection routine commences periodically to “destroy” specific objects that are no longer being used or referenced, or to store them if they have not been used for some period of time. The memory elements used by these objects are made available for reuse. Garbage collection begins at step 1601, and loops for each list of memory elements as indicated by decision step 1603. Once garbage collection finishes for all the lists of memory elements, the garbage collection routine waits at step 1605 for some predetermined period of time before commencing again. The waiting period can depend on any number of conditions or factors. Similarly, the routine loops, as indicated by decision step 1607, for each memory element in a list.

At step 1609, the routine determines whether the element has been assigned an object. If no, the routine returns to step 1611 to increment the loop counter to start the garbage collection routine for the next element, beginning again with the determination at step 1609. If an element is assigned to an object, the routine next checks to see if the reference count for the object is equal to zero. If so, the routine proceeds to steps 1615 and 1617 where the object is “destroyed.” At step 1615, the routine resets the attribute in the list that tracks a reference or point to the next available element in the list, namely nextAvailableElement, to the current element if its reference is less than its current value. The object is removed from the hash table at 1617 before the routine loops back to decision step 1609 to start again. If the element has a non-zero reference count at decision step 1613, the time stamp is checked to determine at step 1619 whether it has “expired.” In other words, if the period since that last time use was requested for the object has exceeded some predetermined time, the routine decides at step 1621 whether or not to store the object based on some criteria, such as its type. If the object is to be stored, it is first copied at step 1623 into some file in storage. Whether or not it is stored, an object whose timestamp has expired is destroyed at steps 1615 and 1617 before the routine loops back to examine the next element in the list.

Once all the elements of a list are examined, the routine determines whether the list is to be compacted at step 1625. If so, it compacts the list at step 1627 before looping back step 1629 to increment the list loop count. Otherwise it loops directly back to the next list. A compacted list is one in which the remaining objects occupy consecutive memory elements, and thus also consecutive positions in the list.

Finally, in reference to FIG. 17, should the SystemObject manager 211 receive a request to destroy an object of a class registered with it, at step 1701, it first determines at step 1703 whether the reference count for that object is equal to zero. If not, an exception is returned and the process returns or ends at step 1705. If the reference count is zero, then the list object that manages that particular type of object is obtained at step 1707, such as by obtaining a reference to the List object managing that list. At step 1709, the attribute in the list that tracks the next available memory element, namely nextAvailableElement, is set equal to the value stored in that object's next available element attribute. The object is then removed form the hash table at step 1717 and the process ends and returns to the beginning at step 1713.

The foregoing description is of a preferred embodiment of the invention, in a particular environment of use, and is intended as but one example of the invention as defined by the appended claims. The programming implementation of the invention described herein may differ from other implementations of the invention as a consequence of differences in programming languages, preferences of programmers and the accommodation of needs of specific application programs. Furthermore, some components or processes described herein as being implemented in an object-oriented manner could be, instead, implemented using other types of programming techniques without departing from the principals of the invention as claimed. For example, a single class may be implemented as multiple classes, and vice versa.

What is claimed is:

1. A method for managing use of memory in an object-oriented computing system comprising:
allocating a predetermined number of elements of a memory for use by objects of a plurality of classes, prior to use of the memory by an object of the plurality classes;
obtaining a free memory element to create an object that is an instance of the one or more classes; and
storing information in the free memory element indicating the object's type.

2. The method of claim 1 further comprising storing information on the usage of each of the plurality of memory elements as an object.

3. The method of claim 1 further comprising storing in each of the plurality of elements of memory with information on the usage of that particular memory element as an object.

4. The method of claim 3, wherein each object stored in a memory element further includes the information on the usage of the memory element.

5. The method of claim 1 further comprising populating the object with data.

6. The method of claim 1 wherein each element is at least as large as a predetermined maximum size for an object of the one more classes.

7. The method of claim 1 wherein each of the classes is derived from a base class including data attributes for storing values for the information for enabling management of the usage of the memory elements.

8. The method of claim 1 further including storing additional information indicating the number of references to the object.

9. The method of claim 8 further including periodically checking the number of references to the object and, if less than one, indicating that the memory element occupied by the object is free.

10. The method of claim 1 further including storing a time stamp in the object indicating a last time the object was referenced.

11. The method of claim 10 further including periodically check the time stamp of the object and, if a predetermined period of time has elapsed, indicating the memory element occupied by the object is free.

12. The method of claim 1 further including assigning a unique code to the object as its identifier.

13. The method of claim 1 further including receiving a request for use of the object, providing in return the object's identifier and incrementing by one the number of references to the object.

14. The method of claim 13 further including storing a reference to the next available element of memory in the allocated elements of memory.

15. A computer readable storage medium encoded with instructions, which, when read by a computer, enable a computer to undertake a process comprising:
allocating a predetermined number of elements of a memory for use by objects of a plurality of classes, prior to use of the memory by an object of the plurality classes;
obtaining a free memory element to create an object that is an instance of the one or more classes; and
storing information in the free memory element indicating the object's type.

16. The computer readable storage medium of claim 15 wherein the process further comprises storing information on the usage of each of the plurality of memory elements as an object.

17. The computer readable storage medium of claim 15 wherein the process further comprises storing in each of the plurality of elements of memory with information on the usage of that particular memory element as an object.

18. The computer readable storage medium of claim 17, wherein each object stored in a memory element further includes the information on the usage of the memory element.

19. The computer readable storage medium of claim 17, wherein the process further comprises populating the object with data.

20. The computer readable storage medium of claim 15, wherein, in the process, each element is at least as large as a predetermined maximum size for an object of the one more classes.

21. The computer readable storage medium of claim 15, wherein each of the classes is derived from a base class including data attributes for storing values for the information for enabling management of the usage of the memory elements.

22. The computer readable storage medium of claim 15, wherein the process further includes storing additional information indicating the number of references to the object.

23. The computer readable storage medium of claim 22 wherein the process further includes periodically checking the number of references to the object and, if less than one, indicating that the memory element occupied by the object is free.

24. The computer readable storage medium of claim 15 wherein the process further includes storing a time stamp in the object indicating a last time the object was referenced.

25. The computer readable storage medium of claim 24 wherein the process further includes periodically check the time stamp of the object and, if a predetermined period of time has elapsed, indicating the memory element occupied by the object is free.

26. The computer readable storage medium of claim 15, wherein the process further includes assigning a unique code to the object as its identifier.

27. The computer readable storage medium of claim 26, wherein the process further includes receiving a request for use of the object, providing in return the object's identifier and incrementing by one the number of references to the object.

28. The computer readable storage medium of claim 15 wherein the process further includes storing a reference to the next available element of memory in the allocated elements of memory.
